(19) United States
(12) Patent Application Publication
(10) Pub. No.: US 2011/0202825 A1
(43) Pub. Date: Aug. 18, 2011

(54) System and Method of Annotating Non-modifiable Documents and Managing Annotations

(75) Inventor: Roman VOLSKY, Columbia, MD (US)

(73) Assignee: FlashNotes, LLC, Columbia, MD (US)

(21) Appl. No.: 12/845,212

(22) Filed: Jul. 28, 2010

Related U.S. Application Data
(60) Provisional application No. 61/304,206, filed on Feb. 12, 2010.

(51) Int. Cl. G06F 17/00

(52) U.S. Cl. 715/230

(57) ABSTRACT

Disclosed is an electronic note-taking program on a computer readable medium, such as a removable USB memory device, CD, internet server, or the like, which has a visual text (preferably, in PDF format) linked together with a word-processing program, such that a reader takes notes associated with the onscreen text. The program simultaneously displays the note-taking screen adjacent to the visual text, or also can switch back and forth between visually reading on a computer display screen and/or reading or printing the notes taken by the reader. The notes will automatically link to the place in the visual text, such that the reader can always see the notes in relation to the visual text. The computer readable medium can include the visual text along with the note-taking program installed thereon and an automatic installation program. The electronic note-taking program combines the advantages and cost savings of materials available in electronic form with the ability to annotate the materials in an electronic medium just as would be available in physical hard-cover materials.

### BACKGROUND

### Field of the Invention

This invention relates to a method and a computerized system for note-taking and annotating electronic non-modifiable files.

### Background of the Invention

The use of electronic books and other electronic media as a companion to classroom instruction, professional workshops and online courses is expanding as the tools to use and disseminate the information become more widespread and users adjust to newer learning methods. The use of electronic materials has numerous advantages. Electronic learning tools allows users to review the materials when time permits, allows the user to use the materials at their own pace and allows users at remote locations to simultaneously view the same materials as others; thus the cost and time expense of travelling for training becomes lower. Additionally, more people can be linked together electronically and the cost and environmental impact of paper publishing and shipping are greatly reduced.

Electronic books are available in a variety of formats including, CD or DVD formats, on PDA, MP3, iPHONE or iPOD platforms, available for online downloads, or on dedicated electronic book devices, for example. Delivery of electronic books can incorporate several formats simultaneously, such as text and audio (U.S. Pat. No. 7,020,663 and U.S. Patent Application No. 2007/0005616, both to Hay et al.), or also incorporate video or allow simultaneous viewing of several text or image files (U.S. Pat. Nos. 7,401,286, 6,408,437 and 5,986,690, U.S. Patent Application Nos. 2009/0300539 and 2009/0241054, all to Discovery Communications, Inc., U.S. Patent Application No. 2009/0241054).

Annotation of electronic books, bookmarking or taking notes associated with “pages” as can be traditionally done with paper books has been a challenge and one stumbling block to the wider acceptance of electronic publishing. Electronic book editing software and methods are available, but the book and the software have to be in an “editable” format, such as XML (U.S. Patent No. 2007/0298399, Shao and Kao). Some programs are available which allows limited annotation of non-modifiable documents and highlighting capabilities along with usage tracking when used as part of a dedicated electronic book hardware appliance, (U.S. Pat. Nos. 7,350,704 and 7,103,848, and U.S. Patent Application No. 2008/0141182, all to International Business Machines Corporation), and which can include the need for a stylus (U.S. Pat. Nos. 7,568,168; 7,496,856, 7,337,389 and 7,028,267 and U.S. Patent Application No. 2009/0271381 (Beezer et al., to Microsoft Corporation). These systems and methods also all require proprietary and expensive software on a user's computer in order to implement the methodology.

There are many additional disadvantages to electronic books. Many user agreements limit the use to the country of purchase, which could be a problem for travelling persons and international students. The incompatible formats and ability of companies supplying content to remove purchased content at any time further limits the use of these products. Students and professors complain that pages cannot be highlighted and marked, as is normal for hard copies of slide presentations, teaching materials or textbooks. Electronic book distributors also offer a limited selection of materials and different publishers control the distribution of their books through different electronic book formats, requiring users to purchase several different pieces of non-compatible expensive hardware on which to read the books from differing distribution sources.

There exists a need for a method and a system and method which will allow simultaneous viewing and the ability of a user to provide searchable annotation in a separate file, which is linked to a non-modifiable document page, and which does not require the installation of an expensive proprietary program on the user's system.

### SUMMARY OF THE INVENTION

The present invention is drawn to a method and a computerized system and method of annotating non-modifiable files. The system based on the method of the invention is supplied to the user on an external memory device or by a connection to a remote internet server, and includes the ability of the note-taker to simultaneously read the non-modifiable file and to annotate each page of the file. An automatically generated notation page is linked to the page of the non-modifiable file and the linkage is saved for later retrieval. The note file is also searchable and can be separately manipulated.

### BRIEF DESCRIPTION OF THE FIGURES

FIG. 1 depicts internet access to a note-taking system housed on a remote server.

FIGS. 2-4 are flow charts of processes used in generating, storing and manipulating notes in a noting taking system.

FIG. 5 depicts a screen shot of a non-modifiable document screen and a user-input note-taking screen.

FIG. 6 shows a saved listing of notes input by a user.

### DETAILED DESCRIPTION OF THE INVENTION

The present invention is drawn to an electronic note-taking program on a computer readable medium, such as a removable USB memory device, CD or the like, which has a visual text (preferably, in PDF format) linked together with a word-processing program, such that a reader takes notes associated with the onscreen text. Alternatively, the system could run on a remote internet server or can be downloaded from a server to the user.

The program simultaneously displays the note-taking screen adjacent to the visual text (or non-modifiable document), or also can switch back and forth between visually reading on a computer display screen and/or reading or printing the notes taken by the reader. The notation page with user-generated notes will automatically link to the page of the visual text, such that the reader can always see the user-generated notes in relation to the visual text. The computer readable medium can include the visual text along with the note-taking program installed thereon and an automatic self-executing program. The electronic note-taking program combines the advantages and cost savings of materials available in electronic form with the ability to annotate the materials in an electronic medium just as would be available in physical hard-cover materials.

“Notation” as used herein can include, but is not limited to, user-generated text, graphics, pictures, non-user generated text such as imported files from word processing programs or content from the internet or imported files such as PDF files and the like, mathematical symbols, musical symbols, and so forth. Notations can be in any language to which the user has an ability to utilize and display, including languages which use non-Latin writing, such as Chinese, Japanese, Korean, Cyrillic, Arabic, Hebrew or Hindi. The notation window is also able to accept stylus-generated input, such as that generated on a notepad using either GRAFFITTI, or equivalent, or the user's own handwriting. “Notation” and “annotation” are synonymous terms.

With the expansion of electronic learning tools and online learning, however comes a greater need to ensure integrity of the materials, so that the materials cannot be changed from their original format and content. Several popular formats have become standards for such dissemination of non-modifiable electronic files. For example, PDF (.pdf file designation) files from Adobe Corp. and TIFF (.tif file designation) are popular formats, as are JPG, PNG, and GIF. The invention includes, but is not limited to original documents in these formats, as well as image and picture file formats, such as .bpm, .pct, .psd, .psp, .thm, .ai, .drw, .eps, .ps, .svg, .fpx, .pcd, .jpx, .jfif, .jp2, j2k, and .j2c. The electronic book format is increasing in popularity but is limited by rigid formats and limited if any user-input or annotation potential.

The method of the of the invention utilizes a system in which a non-modifiable document and a program which allows annotation can be supplied to the user on a non-volatile memory device. The invention can be used by students or as a file-sharing system in a business setting. The non-modifiable document can include textbooks, lecture notes, electronic slide presentations (such as POWERPOINT and the like), user manuals, shop drawings, and so forth. The program of the invention which allows notation can use plain text editors already present on users' computers. The invention can also use word processing programs as known in the art.

Non-volatile memory devices include, but are not limited to semiconductor memory devices, optical storage devices, and magnetic storage devices. Semiconductor memory devices include, but are not limited to: USB flash drives, (also known as, “thumb drives,” “memory sticks,” and “USB memory sticks” among others), flash memory cards, including, SIM cards, smart cards, SD cards, mini SD cards and microSD cards. Optical storage media of the invention include, but are not limited to: CD, CD-ROM, DVD, BD-ROM, read only storage, CD-R, DVD-R, DVD+R, BD-R, write once storage, CD-RW, DVD-RW, DVD+RW, DVD-RAM, and BD-RE. Additionally, remote internet servers may be utilized as memory and storage devices. Internal and external hard drives are also included.

### WORKING EXAMPLES

### Example 1

### Educational Lecture Notes

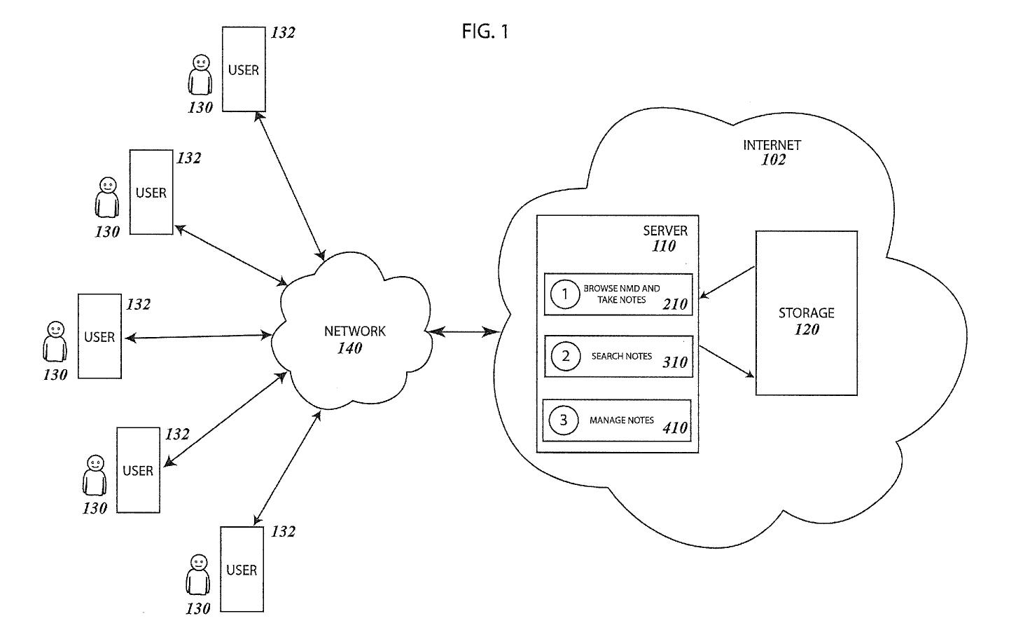

The system of the invention can be available through the internet 102 as shown in FIG. 1. A secure server 110 houses the program of the system. Storage of the notes or files can be optionally be housed on a separate storage unit 120 and then retrieved for further browsing 210, searching 310 and/or file and notes management 410, through the server 110. The users 130 can access the system through a client computer 132, which is connected to a network 140, which in turn has access to the internet 102. Password or other means for access control protection is included at any access point in the system. Cloud computing is included in the invention. Peer-to-peer networks are also envisioned in the invention.

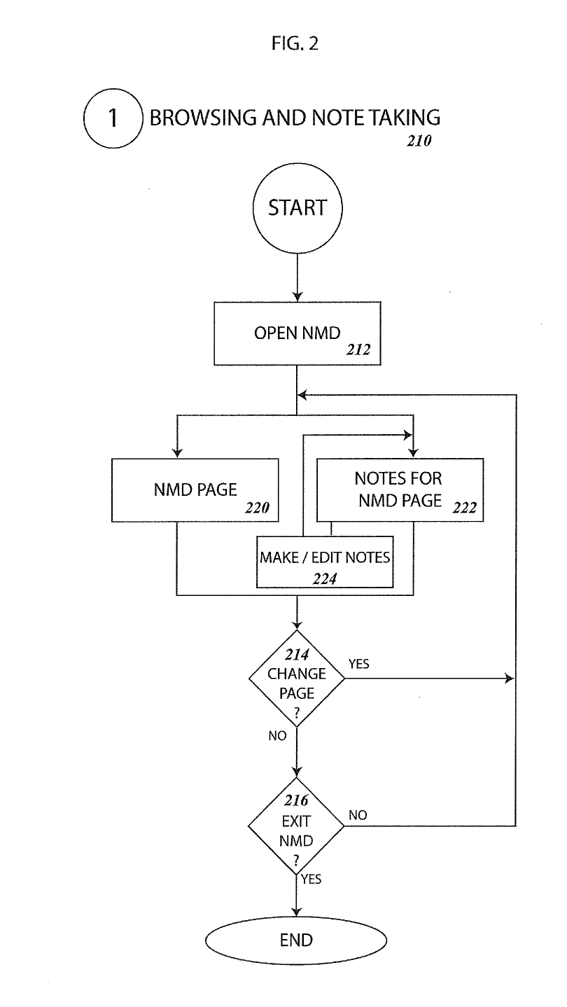

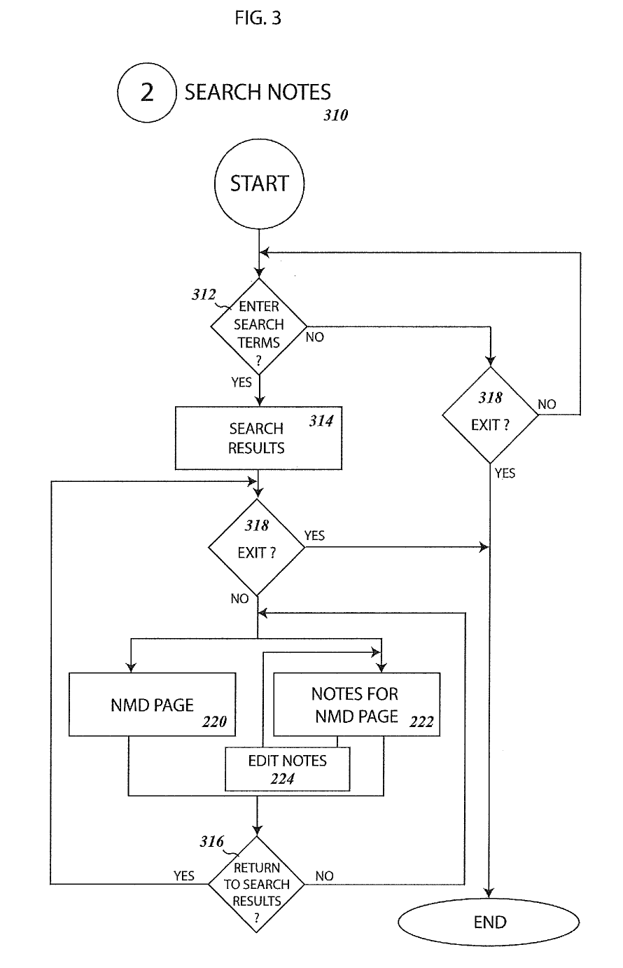

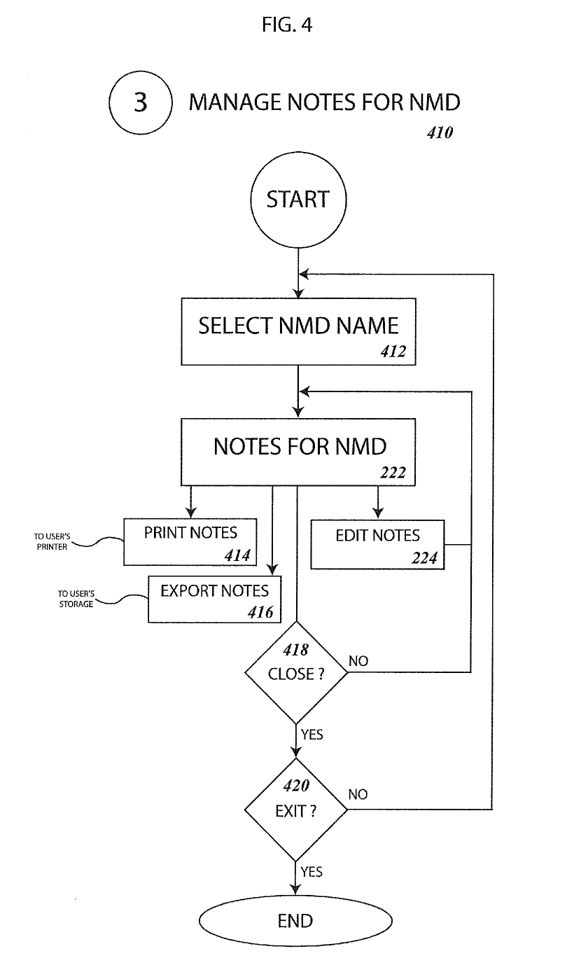

In order to generate notes 210, the user opens a non-modifiable document 212, provided to the user by the system or the invention as shown in FIG. 2. The user then opens the note-taking page 222 and enters a set of desired notes. The notes can include imported data from any external textual sources, such as Internet search results, LEXIS-NEXIS search results, pictures, word processing notes, and the like. The user can continue to make and edit notes 224 as desired. The user can freely change to a different note-taking page 214 in which the user would enter a set of desired notes. The notes can include imported data from any external textual sources, such as Internet search results, LEXIS-NEXIS search results, pictures, word processing notes, and the like. The user can continue to make and edit notes 224 as desired. Alternatively, the user can exit 216 the program at any time, upon which the notes would be saved for future manipulation as shown in FIGS. 2 and 3.

The notes, once generated can be stored and searched 310 by the user who enters a search term 312, receives the search results 314 and either exits the program 318 or returns to the non-modifiable document page 220, continues to add notes to the page 222, to edit the notes 224. The user can then return to a search results 316 or exit 318 as shown in FIG. 2. The notes can be managed 410 at a later date by selecting a non-modifiable document name from a list 412. The notes 222, while having been opened independently from the non-modifiable document 220, can be edited 224, printed 414 or exported to another program or system 416. Alternatively, the program can be closed 418, in which event the notes remain linked to the non-modifiable document 220 in subsequent browsing and note-taking 210 or searching 310; or exited 420.

Since the notes are searchable, the user is able to annotate pages for future recall. If a user wants to be able to recall pages in the original document, all pertaining to a certain concept, then the notes can be used to also search the document, since the notes and the document are linked. This feature allows the user to both use the annotation feature to take their own notes as well as “mark” the original document for future use or searching capabilities. The results of such searches are displayed together with related content of the non-modifiable document. It is anticipated that the system of the invention would be sold in bookstores and/or in locations where other hard copy books are sold. It is also anticipated that the system of the invention can be accessible on a central server providing the content, such as a secure school or company website.

Additionally, the notation for any specific page in the non-modifiable document, could be expanded without size limitations by importing data from any external textual sources (for example Internet search results, Lexis-Nexis search results, pictures, word processing notes, and the like), while still retaining linkage with said non-modifiable document page. A user could do this while browsing the non-modifiable document, or manipulating a notation file separately. The notation obtained from external sources would be saved in the same manner as any user-generated notations.

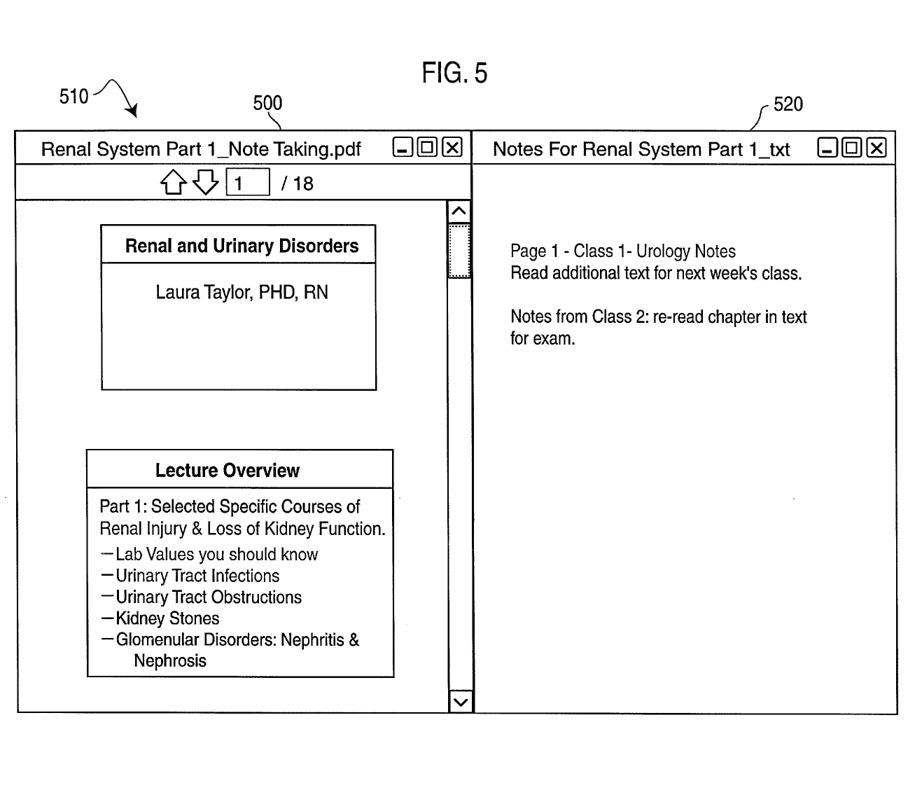

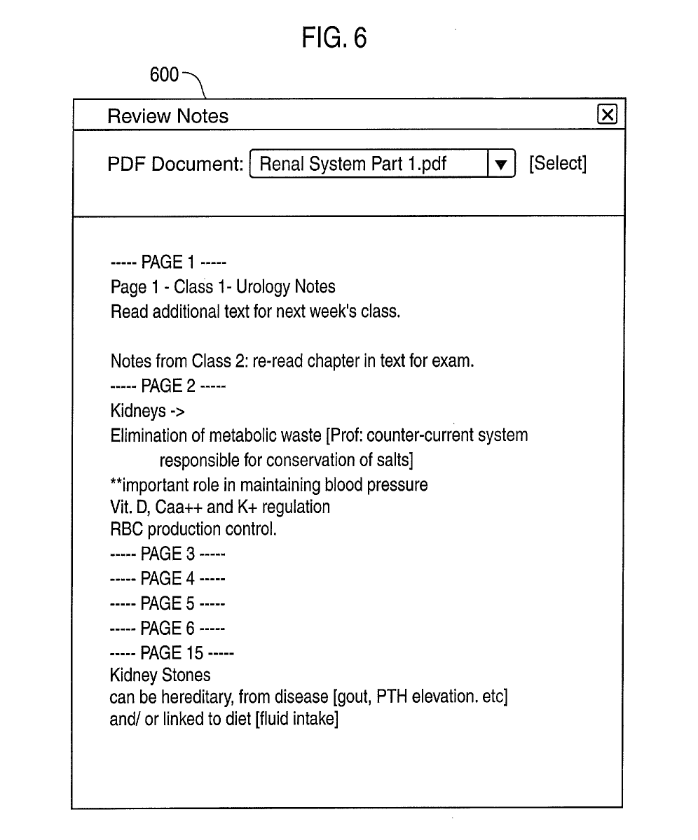

FIG. 5 depicts a screen shot 500 of lecture notes provided to a student in .pdf format 510. The annotations from a student are displayed on the screen adjacent to the page to which the notes correspond 520. The original document and the notes may be stored on a remote server, a memory stick or downloaded to the student's laptop or tabletop computer, for example. The stored notes 520 may be saved and are linked to the document page for later recall. Once the notes are saved, then the notes will appear linked to the document page when the document page is recalled at a later date. The notes can also be separately compiled, viewed, and edited, if desired. A compilation of notes 600 taken by the user can be displayed and printed if desired for future study, as shown in FIG. 6.

The invention includes a computer-implemented method for annotating a non-modifiable page of a document, the method comprising:
a. selecting a non-modifiable document from an electronic medium and displaying said document on a viewing screen; and
b. when upon receiving input from the user to indicate the desire to enter an annotation, providing a separate notation window for display to a user, the notation window for receiving and displaying the annotation provided by the user; and
c. the notation window and user-provided annotation is linked to the content of a particular page from the non-modifiable document; and
d. the linked non-modifiable document and notation window containing the user-provided annotation is automatically saved together when the user navigates to a different page of the non-modifiable document; and
e. said notation window and linked non-modifiable document pages receive user input to navigate directly to any other notation window, which automatically moves together along with the linked non-modifiable document page as the user navigates through the document; and
f. causing said non-modifiable page window to be displayed along with a corresponding notation page; and
g. closing said notation window upon receiving user input not associated with said window;
   such that the user is able to take notes related to each page of the non-modifiable document, which notes are then electronically linked to the related page of the non-modifiable document

The computer-implemented method further comprises searching annotations for information input by user and wherein the non-modifiable document and the program which implements the computer-implemented method are supplied to the user on an external memory device. The computer-implemented method additionally comprises the external memory device including remote interne server or on optical storage devices, magnetic storage devices, and semiconductor memory devices.

The invention also includes a system for annotating a document comprising: one or more processors, a memory storage device accessible to the one or more processors that stores annotations and/or a non-modifiable document, a display monitor, and wherein said system performs a method comprising:
a. selecting a non-modifiable document from an electronic medium and displaying said document on a viewing screen; and
b. when upon receiving input from the user to indicate the desire to enter an annotation, providing a separate notation window for display to a user, the notation window for receiving and displaying the annotation provided by the user; and
c. the notation window and user-provided annotation is linked to the content of a particular page from the non-modifiable document; and
d. a directional button associated with the non-modifiable document which allows the user to navigate to one or more pages of the non-modifiable document;
e. the linked non-modifiable document and notation window containing the user-provided annotation is automatically saved together when the user navigates to a different page of the non-modifiable document; and
f. said notation window and linked non-modifiable document pages receive user input to navigate directly to any other notation window, which automatically moves together along with the linked non-modifiable document page as the user navigates through the document; and
g. causing said non-modifiable page window to be displayed along with a corresponding notation page; and
h. closing said notation window upon receiving user input not associated with said window;
   such that the user is able to take notes related to each page of the non-modifiable document, which notes are then electronically linked to the related page of the non-modifiable document

The invention additionally includes a system for annotating a non-modifiable document and further including a capability to search annotations for information input by user. The system for annotating a non-modifiable document includes the non-modifiable document and the program which implements the computer-implemented method is supplied to the user on an external memory device.

Having now fully described this invention, it will be understood to those of ordinary skill in the art that the same can be performed within a wide and equivalent range of conditions, formulations, and other parameters without affecting the scope of the invention or any embodiment thereof. All patents and publications cited herein are incorporated by reference in their entirety.

I claim:

1. A computer-implemented method for annotating a non-modifiable page of a document, the method comprising:
a. selecting a non-modifiable document from an electronic medium and displaying said document on a viewing screen; and
b. when upon receiving input from the user to indicate the desire to enter an annotation, providing a separate notation window for display to a user, the notation window for receiving and displaying the annotation provided by the user; and
c. the notation window and user-provided annotation is linked to the content of a particular page from the non-modifiable document; and
d. the linked non-modifiable document and notation window containing the user-provided annotation is automatically saved together when the user navigates to a different page of the non-modifiable document; and
e. said notation window and linked non-modifiable document pages receive user input to navigate directly to any other notation window, which automatically moves together along with the linked non-modifiable document page as the user navigates through the document; and
f. causing said non-modifiable page window to be displayed along with a corresponding notation page; and
g. closing said notation window upon receiving user input not associated with said window;
such that the user is able to take notes related to each page of the non-modifiable document, which notes are then electronically linked to the related page of the non-modifiable document.

2. The computer-implemented method of claim 1, further comprising searching annotations for information input by user.

3. The computer-implemented method of claim 1, wherein the non-modifiable document and the program which implements the computer-implemented method are supplied to the user on an external memory device.

4. The computer-implemented method of claim 3, wherein the external memory device is selected from the group consisting of: a remote internet server, optical storage devices, magnetic storage devices, and semiconductor memory devices.

5. A system for annotating a document comprising: one or more processors, a memory storage device accessible to one or more processors that stores annotations and/or a non-modifiable document, a display monitor, and wherein said system performs a method comprising:
a. selecting a non-modifiable document from an electronic medium and displaying said document on a viewing screen; and
b. when upon receiving input from the user to indicate the desire to enter an annotation, providing a separate notation window for display to a user, the notation window for receiving and displaying the annotation provided by the user; and
c. the notation window and user-provided annotation is linked to the content of a particular page from the non-modifiable document; and
d. a directional button associated with the non-modifiable document which allows the user to navigate to one or more pages of the non-modifiable document;
e. the linked non-modifiable document and notation window containing the user-provided annotation is automatically saved together when the user navigates to a different page of the non-modifiable document; and
f. said notation window and linked non-modifiable document pages receive user input to navigate directly to any other notation window, which automatically moves together along with the linked non-modifiable document page as the user navigates through the document; and
g. causing said non-modifiable page window to be displayed along with a corresponding notation page; and
h. closing said notation window upon receiving user input not associated with said window;
such that the user is able to take notes related to each page of the non-modifiable document, which notes are then electronically linked to the related page of the non-modifiable document.

6. The system for annotating a document of claim 5, further comprising searching annotations for information input by user.

7. The system for annotating a document of claim 5, wherein the non-modifiable document and the program which implements the computer-implemented method are supplied to the user on an external memory device.

8. The system for annotating a document of claim 7, wherein the external memory device is selected from the group consisting of: a remote internet server, optical storage devices, magnetic storage devices, and semiconductor memory devices.
